(19) United States
(12) Patent Application Publication
(10) Pub. No.: US 2005/0069158 A1
(43) Pub. Date: Mar. 31, 2005

(54) Packaged piezoelectric exciter module

(76) Inventors: Yao Tsun Lu, Taoyuan (TW); Chih Ming Yang, Taoyuan (TW)

Correspondence Address: Yao Tsun Lu, 235 Chung - Ho, Box 8-24, Taipei, TW

(21) Appl. No.: 10/858,455

(22) Filed: Jun. 2, 2004

Related U.S. Application Data
(63) Continuation-in-part of application No. 10/673,299, filed on Sep. 25, 2003.

(51) Int. Cl. H04R 25/00

(52) U.S. Cl. 381/190

(57) ABSTRACT

A packaged piezoelectric exciter module comprises an insulating bracket, a positive conductive portion, a negative conductive portion and at least one exciter plate. The positive and negative conductive portions and the exciter plate are packed within the insulating bracket. The exciter plate is a laminated plate having a metal layer between two piezoelectric layers. The metal layer has at least one boundary portion so that the thereof uncovered by the piezoelectric layers. The piezoelectric layers are connected to the positive conductive portion, and the boundary portion is connected to the negative conductive portion. The positive and negative conductive portions each have at least one connecting pin extended out of the insulating bracket. Thereby, the positive and negative conductive portions and the exciter plates are packaged as a module for being connected to an electric connector or attached to a circuit board.

The present invention is a continuation in part (CIP) of U.S. Pat. Ser. No. 10/673,299, assigned to the inventor of the present invention, and thus the content of the invention is incorporated into the specification of the invention.

### FIELD OF THE INVENTION

The present invention relates to packaged piezoelectric exciter modules, more particularly to a packaged piezoelectric exciter module wherein a positive conductive portion and a negative conductive portion are packed within an insulating bracket, so that it can be attached to a substrate board or connected to an electric connector.

### DESCRIPTION OF THE PRIOR ART

A piezoelectric exciter is a device that can convert positive and negative electrical signals to sound. It has been widely used in the market to replace the audio device of conventional speakers. Because of its compact size, the piezoelectric exciter is suitable for being installed at a computer case, a peripheral device of a computer, a television set, a telephone, an RF broadcasting device, an electronic toy, a banking machine, etc.

However, in the piezoelectric exciters of the prior art the positive and the negative conductive portions are connected to the exciter plates by soldering, which is disadvantageous in extra soldering labor cost and oxidation of the connecting points between the conducting plates and the exciter plates as they are exposed to the air. Further, the spacing between parallel exciter plates is so thin that the soldered connecting points are easy to touch each other as the exciter plates are vibrating, resulting in a short circuit. It is a further disadvantage that the soldered connecting points cause extra load for the exciter plates, which may change the frequencies of the sound the plates produce.

### SUMMARY OF THE INVENTION

The objective of the present invention is to provided a packaged piezoelectric exciter module wherein a positive conductive portion and a negative conductive portion are packed within an insulating bracket, so that it can be attached to a substrate board as an audio module.

To achieve above object, the present invention provides a packaged piezoelectric exciter module. The module comprises an insulating bracket, a positive conductive portion, a negative conductive portion and at least one exciter plate. The positive and negative conductive portions and the exciter plate are packed within the insulating bracket. The exciter plate is a laminated plate having a metal layer between two piezoelectric layers. The metal layer has at least one boundary portion which exposes from the piezoelectric layers. The piezoelectric layers are connected to the positive conductive portion, and the outer metallic boundary portion of the metal layer is connected to the negative conductive portion. The positive and negative conductive portions each have at least one connecting pin extended out of the insulating bracket. Thereby, the positive and negative conductive portions and the exciter plates are packaged as a module for being connected to an electric connector or attached to a circuit board.

The various objects and advantages of the present invention will be more readily understood from the following detailed description when read in conjunction with the appended drawings.

### BRIEF DESCRIPTION OF THE DRAWINGS

FIG. 1 is a perspective view of a preferred embodiment of the present invention wherein a positive conductive portion, a negative conductive portion and two exciter plates are disposed on a T-shaped insulating bracket.

FIG. 2 is a lateral view of a preferred embodiment of the present invention for illustrating the location of the lateral connecting pins of the positive and the negative conductive portions after the connecting pins on the top and the bottom surfaces being removed.

FIG. 3 is a lateral view of another preferred embodiment of the present invention for illustrating the location of the lateral connecting pins of the positive and the negative conductive portions after the connecting pins on the top and the bottom surfaces being removed.

FIG. 4 is the 4-4 cross-sectional view of the preferred embodiment in FIG. 2 for illustrating the configuration of the positive conductive portion.

FIG. 5 is the 5-5 cross-sectional view of the preferred embodiment in FIG. 2 for illustrating the configuration of the negative conductive portion.

FIG. 6 is the 6-6 cross-sectional view of the preferred embodiment in FIG. 3 for illustrating the configuration of the positive conductive portion.

FIG. 7 is the 7-7 cross-sectional view of the preferred embodiment in FIG. 3 for illustrating the configuration of the negative conductive portion.

FIG. 8 illustrates the lateral connecting pins of the positive and the negative conducting the present invention being connected to a substrate board.

FIG. 9 illustrates the bottom connecting pins of the positive and the negative conducting the present invention being connected to a substrate board.

FIG. 10 is a schematic view showing that the top connecting pins of the positive and the negative conductive portions are embedded with respective dices.

FIG. 11 is a schematic view showing that a wireless module is installed to the present invention, wherein the wireless module is embedded into the top connecting pins of positive and negative conductive elements of the present invention.

FIG. 12 is a perspective view of another preferred embodiment of the present invention wherein the insulating bracket forms a two-sided frame for protecting the exciter plates therein.

FIG. 13 is a perspective view of another preferred embodiment of the present invention wherein the boundary portion on the metal layer is formed as a convex portion.

### DETAILED DESCRIPTION OF THE PREFERRED EMBODIMENTS

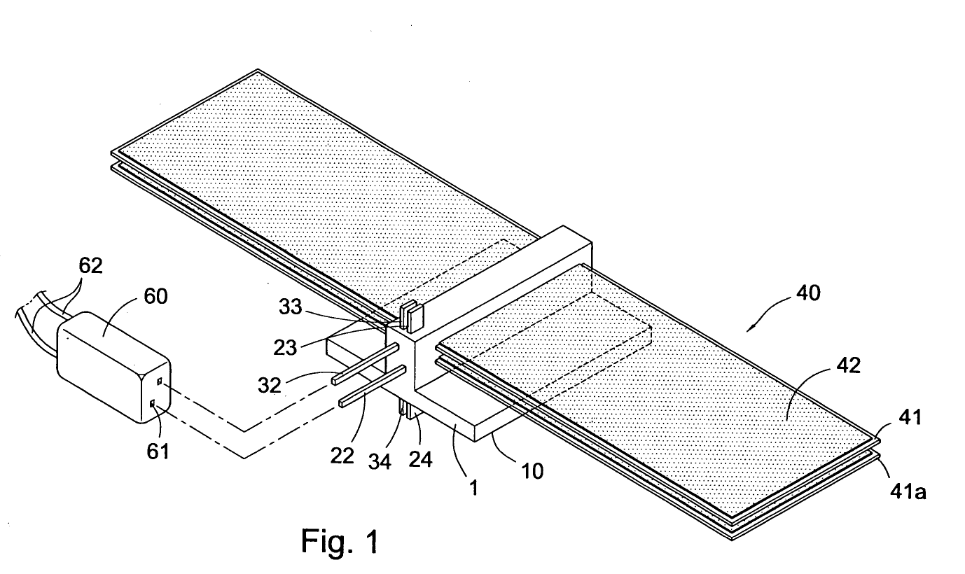

Referring to FIG. 1 to 5, a packaged piezoelectric exciter module according to the present invention comprises a T-shaped insulating bracket 1, a positive conductive portion 2, a negative conductive portion 3 and two exciter plates 40, wherein the T-shaped insulating bracket 1, the positive conductive portion 2 and the exciter plates 40 are mounted on the T-shaped insulating bracket 1.

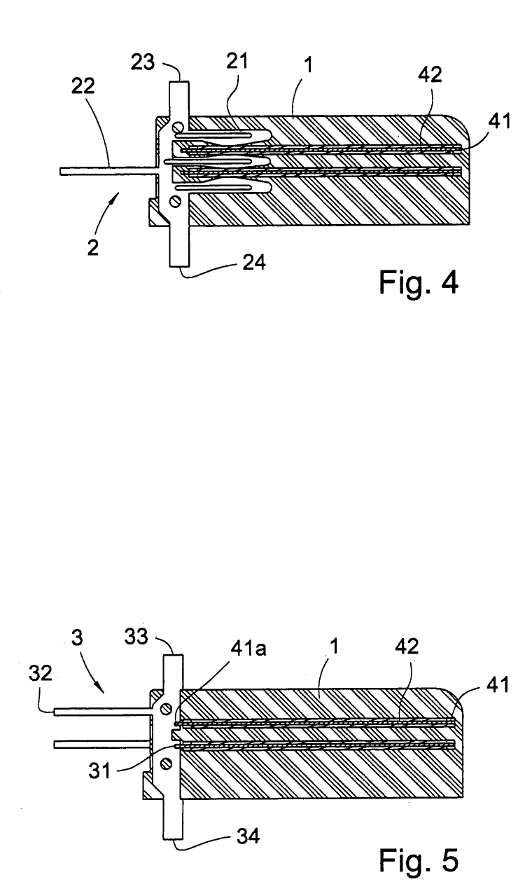

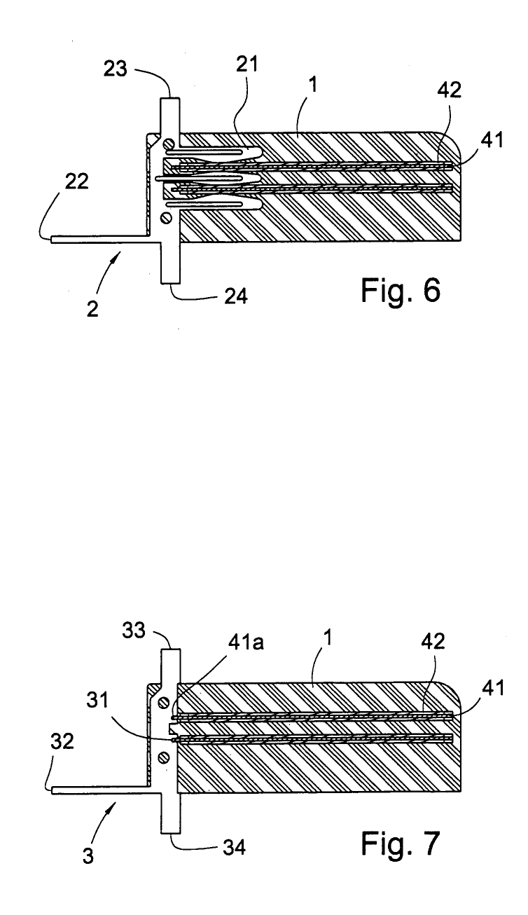

Each of the exciter plates 40 is a laminated plate that includes a metal layer 41 and two piezoelectric layers 42 attached with electrodes, as shown in FIG. 4. Sandwiched by the piezoelectric layers 42, the metal layer 41 is formed with at least one exposed boundary portion 41a so as to expose out of the piezoelectric layers. The boundary portion 41a can be formed as a metallic outer frame around an exciter plate 40 as shown in FIG. 1 or be formed as a metallic convex portion 41b as shown in FIG. 13.

Three contact terminals 21 are extended from the positive conductive portion 2, respectively connecting the piezoelectric layers 42 of the exciter plates 40, as shown in FIGS. 1 and 4. The positive conductive portion 2 further includes three connecting pins 23, 24, 22 respectively extended outwardly from the top portion, the bottom portion and a side surface of the T-shaped insulating bracket 1.

The negative conductive portion 3 includes two clamp openings 31 respectively connected to the boundary portion 41a or 41b of the metal layers 41 of the exciter plates 40. The negative conductive portion 3 further includes three connecting pins 33, 34, 32 respectively extended outwardly from the top, bottom and side surfaces of the T-shaped insulating bracket 1.

Thereby, those two exciter plates 40, the positive conductive portion 2 and the negative conductive portion 3 can be packed with the T-shaped insulating bracket 1 to form a conducing module as shown in FIG. 1. The conducting module can be connected to a connector 60 or surface-mounted on a substrate board 50.

Furthermore, the T-shaped insulating bracket 1 may package only one aforesaid exciter plate 40, together with a positive conductive portion 2 and a negative conductive portion 3.

To connect the present invention to the circuit 53 of a substrate board 50, the connecting pins 23, 33, 22 and 32 on the top surface and on a side surface of the T-shaped insulating bracket 1 are firstly taken away, as shown in FIG. 4 and 5. Therefore, the T-shaped insulating bracket 1 only has connecting pins 24, 34 on the bottom surface thereof, as shown in FIG. 1 and 9. The connecting pins 24, 34 are inserted into corresponding slots 51 on the substrate board 50 so that the packaged piezoelectric exciter module can be electrically connected to the circuit 53 of the substrate board 50. Thereby, the resonant audio signals produced in the piezoelectric exciters can be transmitted.

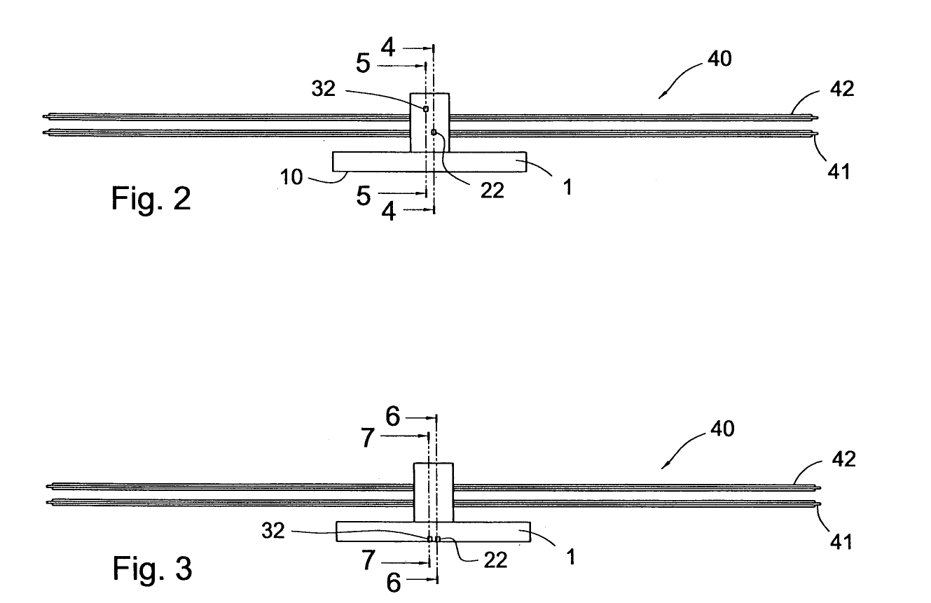

To connect the present invention to a connector 60, the connecting pins 23, 33, 24 and 34 on the top surface and on the bottom surface of the T-shaped insulating bracket 1 are firstly taken away so that only the connecting pins 22, 32 on a side surface are left, as shown in FIGS. 1 and 2. The connecting pins 22, 32 are inserted into corresponding sockets 61 on the connector 60 so that the packaged piezoelectric exciter module is electrically connected to the connector 60. Thereby, the resonant audio signals produced in the piezoelectric exciters can be transmitted.

Further, the connecting pins 22, 32, 24 and 34 respectively on a side and the bottom surface of the T-shaped insulating bracket 1 can be cut off, leaving the connecting pins 23 and 33 for connection, as shown in FIG. 1. Thereby, a connector having compatible sockets can be attached for driving the exciter plates 40 of the packaged piezoelectric exciter module.

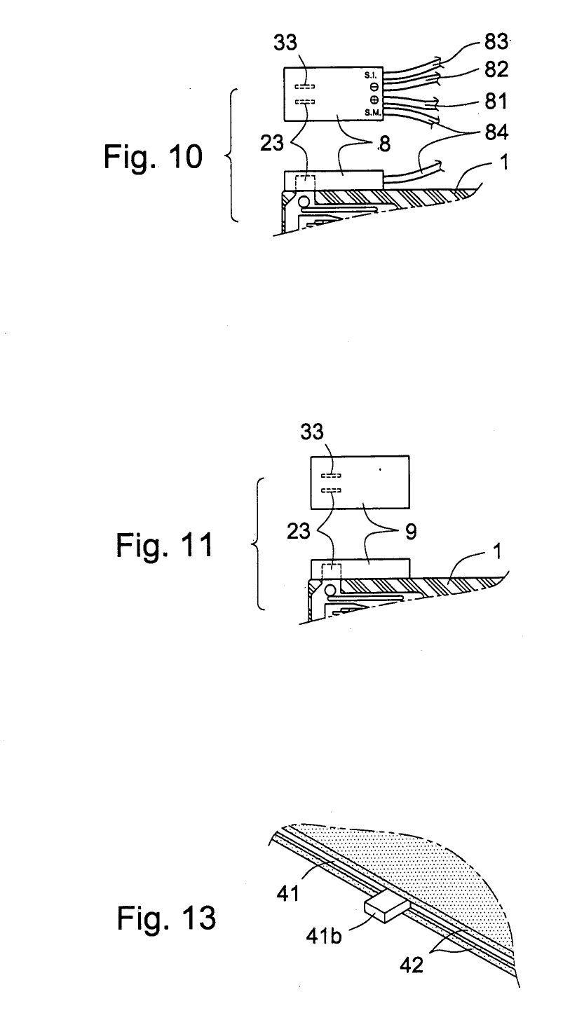

Besides, in the present invention, the driving circuit of the exciter can be made as a dice 8, as shown in FIG. 10. The driving circuit is formed by assembling a DC converter with an amplifier (AMP) so as to be formed as an integrated circuit (IC). The connecting pins 23 and 33 are mounted to the input ports of the dice 8. Moreover, the output ports of the dice 8 have a sound source positive electrode port (V+) 81, a sound source negative electrode port (V−) 82, a signal input port 83 and a standby port 84 for being used with other external devices.

Further, in the present invention can use a wireless module 9. The wireless module 9 is mounted to the connecting pins 23 and 33, as shown in FIG. 11. The wireless module 9 has same communicative frequency of wireless signals with another wireless in external devices. Thereby, the audio signals produced in the piezoelectric exciters can be transmitted.

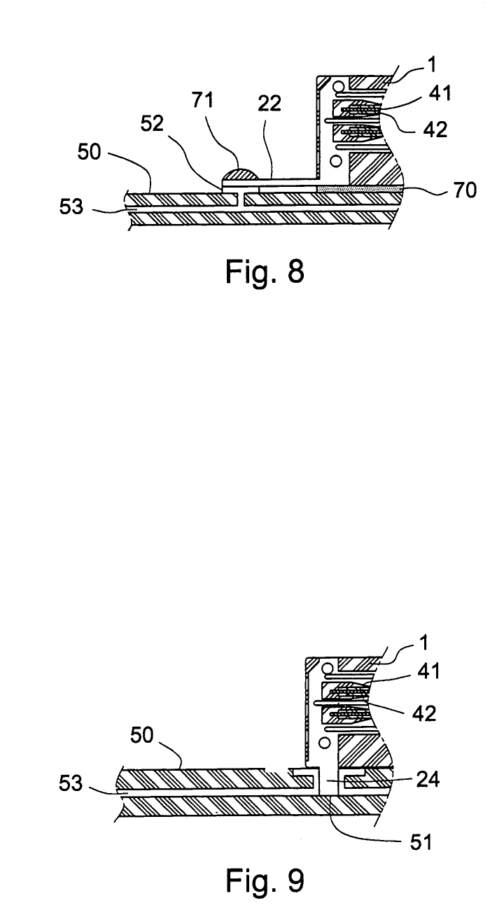

Further, the connecting pins 22, 32 respectively of the positive conductive portion 2 and the negative conductive portion 3 that are extended out of a side surface of the T-shaped insulating bracket 1 can be changed to located on the bottom surface of the T-shaped insulating bracket 1, as shown in FIG. 3, 6 and 7. In this preferred embodiment, the connecting pins 23, 33, 24 and 34 are cut off, and a layer of glue 70 is applied to the bottom surface of the T-shaped insulating bracket 1, so that the T-shaped insulating bracket 1 can be attached to a substrate board 50. The connecting pins 22 and 32 are then connected to corresponding contact points 52 on the substrate board 50 by using solder 71, as shown in FIG. 8. The circuit 53 of the substrate board 50 is for driving the packaged piezoelectric exciter module.

Further, the connecting pins 22 and 32 respectively of the positive conductive portion 2 and the negative conductive portion 3 that are extended out of a side surface of the T-shaped insulating bracket 1 can be respectively connected to wires 62 by soldering, so that driving signals can be transmitted from outside to stimulate the packaged piezoelectric exciter module to resonate.

Further, the base portion 10 of the T-shaped insulating bracket 1 can be stuck to various audio instruments as needed, such as a computer case, a peripheral device of a computer, a television set, a telephone, an RF broadcasting device, an electronic toy, a banking machine, etc. The T-shaped insulating bracket 1 is made of materials suitable for packaging operation, such as Acrylonitrile Butadiene Styrene (ABS).

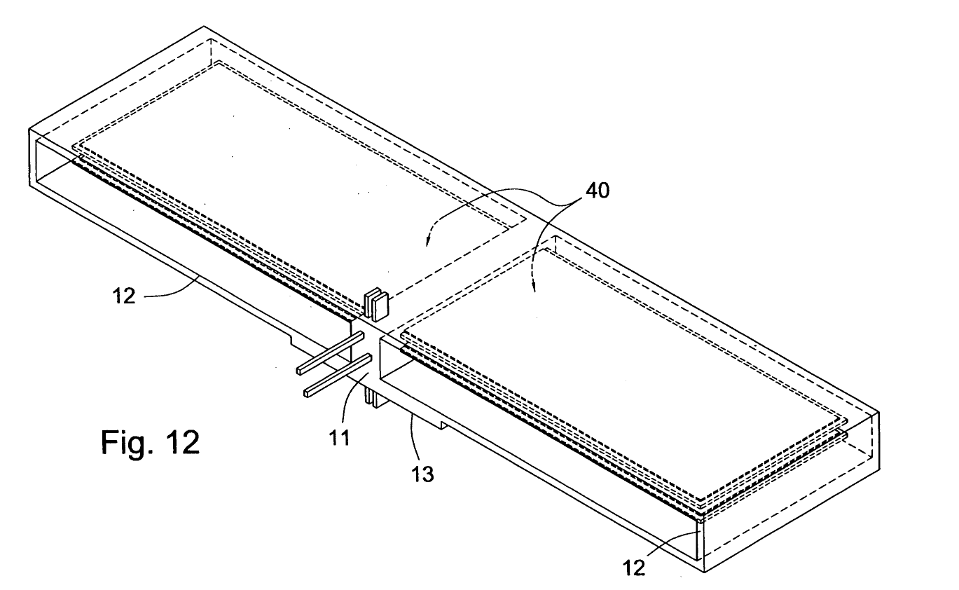

As shown in FIG. 12, the T-shaped insulating bracket 11 of the present invention can be enlarged to form a two-sided frame 12, so that the exciter plates 40 are suspended between and protected by the frame 12. However, the T-shaped insulating bracket 11 still has a bottom surface 13 extended out of the region defined by the frame 12, so that the packaged piezoelectric exciter module can be attached on an audio device.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claim.

1. A packaged piezoelectric exciter module, comprising:
at least one exciter plate being a laminated plate having a metal layer sandwiched between two piezoelectric layers, said metal layer having at least one boundary portion exposing from said piezoelectric layers;
a positive conductive portion connected to said piezoelectric layers, said positive conductive portion having at least one outwardly extended connecting pin;
a negative conductive portion connected to said boundary portion of said metal layer, said negative conductive portion having at least one outwardly extended connecting pin; and
an insulating bracket for packaging said exciter plate, said positive conductive portion and said negative conductive portion.

2. The packaged piezoelectric exciter module of claim 1 wherein said boundary portion is formed as a metallic outer frame around an exciter plate.

3. The packaged piezoelectric exciter module of claim 1 wherein said boundary portion is formed as a metallic convex portion.

4. The packaged piezoelectric exciter module of claim 1 wherein said connecting pins of said positive conductive portion and said negative conductive portion are extended from the top surface of said insulating bracket.

5. The packaged piezoelectric exciter module of claim 1 wherein said connecting pins of said positive conductive portion and said negative conductive portion are extended from the bottom surface of said insulating bracket.

6. The packaged piezoelectric exciter module of claim 1 wherein said connecting pins of said positive conductive portion and said negative conductive portion are extended from a side surface of said insulating bracket.

7. The packaged piezoelectric exciter module of claim 1 wherein said positively conductive portion is further provided with a plurality of extended contact terminals to contact with said piezoelectric layers.

8. The packaged piezoelectric exciter module of claim 1 wherein said negatively conductive portion is further provided with a plurality of clamp openings to engage with said boundary portion of said metal layer.

9. The packaged piezoelectric exciter module of claim 1 wherein said connecting pins are mounted to said input ports of said dice, and said output ports of said dice include at least one of a sound source positive electrode post, a sound source negative electrode post, a signal input post, and a standby port for being used with other external devices.

10. The packaged piezoelectric exciter module of claim 1 wherein said connecting pins are mounted to said wireless module.

11. The packaged piezoelectric exciter module of claim 1 wherein said insulating bracket forms a two-sided frame so that said exciter plate can be suspended therein, and wherein a central portion of said insulating bracket bulges out of the region defined by said two-sided frame to form a bottom surface.
